(19) United States
(12) Patent Application Publication
(10) Pub. No.: US 2018/0197482 A1
(43) Pub. Date: Jul. 12, 2018

(54) DISPLAY DEVICE AND DRIVING METHOD THEREOF

(71) Applicant: Samsung Display Co., Ltd., Yongin-si (KR)

(72) Inventors: Sang Moo CHOI, Yongin-si (KR); Min Kyu WOO, Yongin-si (KR); Jae Sic LEE, Yongin-si (KR)

(21) Appl. No.: 15/864,971

(22) Filed: Jan. 8, 2018

(30) Foreign Application Priority Data
Jan. 10, 2017 (KR) 10-2017-0003511

(51) Int. Cl. G09G 3/3266

(52) U.S. Cl. CPC G09G 3/3266; G09G 2320/08; G09G 2340/04; G09G 2310/08

(57) ABSTRACT

A display device including a display area, first-group pixels and first-group scan lines in a first pixel area, second-group pixels and second-group scan lines in a second pixel area, third-group pixels and third-group scan lines in a third pixel area, a first scan driver to drive the first-group scan lines, a second scan driver to drive the second-group scan lines, and a third scan driver to drive the third-group scan lines, wherein the second scan driver sequentially drives the second-group scan lines during one frame period, and the first and third scan drivers alternately drive the first-group scan lines and the third-group scan lines while the second-group scan lines are driven, and wherein at least one of the first and third scan drivers repeatedly drives at least some of the first-group scan lines and the third-group scan lines two times or more during said one frame period.

### CROSS-REFERENCE TO RELATED APPLICATION

This application claims priority to, and the benefit of, Korean Patent Application No. 10-2017-0003511 filed in the Korean Intellectual Property Office on Jan. 10, 2017, the entire contents of which are incorporated herein by reference.

### BACKGROUND

### 1. Field

Embodiments of the present invention relate to a display device and a driving method thereof.

### 2. Description of the Related Art

Recently, various electronic devices that can be worn directly on the body have been developed. These devices are commonly referred to as wearable electronic devices.

As an example of a wearable electronic device, a head mounted display device (hereinafter, briefly referred to as a “HMD”) displays a realistic image, and provides a high degree of immersion. Such a HMD has been used for various purposes including watching movies.

### SUMMARY

Embodiments of the present invention provide a display device with improved display quality and a driving method thereof.

An embodiment of the present invention provides a display device including a display area including a first pixel area, a second pixel area, and a third pixel area, which are sequentially arranged, and configured to display an image at different areas depending on a first mode or a second mode, first-group pixels and first-group scan lines in the first pixel area, second-group pixels and second-group scan lines in the second pixel area, third-group pixels and third-group scan lines in the third pixel area, a first scan driver configured to drive the first-group scan lines, a second scan driver configured to drive the second-group scan lines, and a third scan driver configured to drive the third-group scan lines, wherein, in the second mode, the second scan driver is configured to sequentially drive the second-group scan lines during one frame period, and the first and third scan drivers are configured to alternately drive the first-group scan lines and the third-group scan lines while the second-group scan lines are driven, and wherein at least one of the first and third scan drivers repeatedly drives at least some of the first-group scan lines and the third-group scan lines two times or more during said one frame period in the second mode.

Said one frame period may include a plurality of horizontal periods, and the first scan driver, the second scan driver, and the third scan driver may be configured to supply a same number of scan signals to corresponding scan lines of the first-group scan lines, the second-group scan lines, and the third-group scan lines during each of the horizontal periods in the second mode.

Said one frame period may include a plurality of horizontal periods, the second scan driver may be configured to supply a second scan signal to one of the second-group scan lines during each of the horizontal periods in response to the second mode, and the first scan driver and the third scan driver may be configured to alternately supply a first scan signal or a third scan signal to one of the first-group scan lines or one of the third-group scan lines during different ones of the horizontal periods.

The first scan signal or the third scan signal may be supplied concurrently with the second scan signal.

Said one frame period may include sequential first, second, and third periods, and, in the second mode, the first scan driver may be configured to sequentially drive the first-group scan lines during each of the first period and the third period, and the third scan driver is configured to sequentially drive the third-group scan lines during the second period.

Said one frame period may further include a fourth period following the third period, and the third scan driver may sequentially drive the third-group scan lines during the fourth period in the second mode.

The second scan driver may be configured to sequentially drive different ones of the second-group scan lines during each of the first period, the second period, and the third period.

The first scan driver, the second scan driver, and the third scan driver may be configured to collectively sequentially drive the first-group scan lines, the second-group scan lines, and the third-group scan lines in the first mode.

The display device may further include a timing controller configured to respectively supply a first start signal, a second start signal, and a third start signal to the first scan driver, the second scan driver, and the third scan driver.

The timing controller may be configured to sequentially supply the first start signal, the second start signal, and the third start signal in the first mode.

The timing controller may be configured to concurrently supply the first start signal and the second start signal in the second mode.

The timing controller may be configured to supply the third start signal in synchronization with a first scan signal supplied to a last first-group scan line of the first-group scan lines.

The display device may further include data lines in the display area crossing the first-group scan lines, the second-group scan lines, and the third-group scan lines, and a data driver configured to supply a data signal to the data lines.

The data driver may be configured to sequentially supply a data signal corresponding to a first horizontal line to a last horizontal line of the second pixel area during said one frame period in the second mode.

The display area may be configured to displays the image in the first pixel area, the second pixel area, and the third pixel area in response to the first mode, and is configured to display the image only in the second pixel area in the second mode.

The display device may be configured to be driven in the second mode when mounted to a wearable device covering the first pixel area and the third pixel area, and is configured to be driven in the first mode otherwise.

An embodiment of the present invention provides a driving method of a display device including a first pixel area, a second pixel area, and a third pixel area, which are sequentially arranged, the method including supplying a data signal to the first pixel area, the second pixel area, and the third pixel area while sequentially scanning the first pixel area, the second pixel area, and the third pixel area when the display device is driven in a first mode, and supplying a data signal to the second pixel area while scanning the second pixel area, and alternately scanning the first pixel area and the third pixel area while the second pixel area is scanned, when the display device is driven in a second mode, wherein the first pixel area and the third pixel area are repeatedly scanned until the scan of the second pixel area is completed when the display device is driven in the second mode.

The method may further include concurrently supplying a scan signal to a first first-group scan line of the first pixel area and to a first second-group scan line of the second pixel area when the display device is driven in the second mode.

The method may further include, when the display device is driven in the second mode concurrently supplying the scan signal to a last first-group scan line of the first pixel area and to a k^{th} (k is a natural number that is greater than 2) second-group scan line of the second pixel area during a k^{th} horizontal period in each frame period, and concurrently supplying the scan signal to a (k+1)^{th} second-group scan line of the second pixel area and to a first third-group scan line of the third pixel area during a (k+1)^{th} horizontal period that is subsequent to the k^{th} horizontal period.

The method may further include displaying an image in the first pixel area, the second pixel area, and the third pixel area when the display device is driven in the first mode, and displaying the image only in the second pixel area when the display device is driven in the second mode.

According to the described embodiments, the first and third-group scan lines of the non-visible display area, as well as the second-group scan lines of the visible display area, may be driven during the period in which the display device is driven in the second mode to display the effective image only in a portion of the display area. Accordingly, it is possible to prevent characteristics of the driving transistors included in the pixels from being differently set between the pixel areas while acquiring a time necessary for the driving.

In addition, according to the described embodiments, when the display device is driven in the second mode, one of the first, third, and fourth-group scan lines is driven together with the second-group scan line during the period in which each of the second-group scan lines is driven. Therefore, it is possible to improve a display quality of the display device by applying a constantly uniform drive load to the scan drivers.

### BRIEF DESCRIPTION OF THE DRAWINGS

FIG. 1A to FIG. 1C illustrate a wearable device according to the present embodiment and a state in which a display device is mounted to the wearable device.

FIG. 2 schematically illustrates a display device according to the present embodiment.

FIG. 3 illustrates a display device according to the present embodiment.

FIG. 4 illustrates an example of a pixel shown in FIG. 3.

FIG. 5 illustrates an example of scan drivers shown in FIG. 3.

FIG. 6 illustrates an example of a driving timing of scan drivers when the display device shown in FIG. 3 is driven in a first mode.

FIG. 7 schematically illustrates a supply order of scan signals supplied to a display area for a frame period when the display device shown in FIG. 3 is driven in the first mode.

FIG. 8 illustrates an example of an image that is displayed in a display area when the display device shown in FIG. 3 is driven in the first mode.

FIG. 9 illustrates an example of a driving timing of scan drivers when the display device shown in FIG. 3 is driven in a second mode.

FIG. 10 schematically illustrates a supply order of scan signals supplied to a display area for each frame period when the display device shown in FIG. 3 is driven in the second mode.

FIG. 11 illustrates an example of an image that is displayed in the display area when the display device shown in FIG. 3 is driven in the second mode.

FIG. 12 illustrates a display device according to the present embodiment.

FIG. 13 schematically illustrates a display device according to the present embodiment.

FIG. 14 illustrates a display device according to the present embodiment.

FIG. 15 illustrates an example of scan drivers shown in FIG. 14.

FIG. 16 illustrates an example of a driving timing of scan drivers when the display device shown in FIG. 14 is driven in the second mode.

FIG. 17 schematically illustrates a supply order of scan signals supplied to a display area and a dummy area for each frame period when the display device shown in FIG. 14 is driven in the second mode.

### DETAILED DESCRIPTION

Features of the inventive concept and methods of accomplishing the same may be understood more readily by reference to the following detailed description of embodiments and the accompanying drawings. Hereinafter, embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

In the following description, for the purposes of explanation, numerous specific details are set forth to provide a thorough understanding of various embodiments. It is apparent, however, that various embodiments may be practiced without these specific details or with one or more equivalent arrangements. In other instances, well-known structures and devices are shown in block diagram form in order to avoid unnecessarily obscuring various embodiments.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element, layer, region, or component is referred to as being “on,” “connected to,” or “coupled to” another element, layer, region, or component, it can be directly on, connected to, or coupled to the other element, layer, region, or component, or one or more intervening elements, layers, regions, or components may be present. However, “directly connected/directly coupled” refers to one component directly connecting or coupling another component without an intermediate component. In addition, it will also be understood that when an element or layer is referred to as being “between” two elements or layers, it can be the only element or layer between the two elements or layers, or one or more intervening elements or layers may also be present.

For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the term “exemplary” is intended to refer to an example or illustration.

When a certain embodiment may be implemented differently, a specific process order may be performed differently from the described order. For example, two consecutively described processes may be performed substantially at the same time or performed in an order opposite to the described order.

Various embodiments are described herein with reference to sectional illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

The electronic or electric devices and/or any other relevant devices or components according to embodiments of the present invention described herein may be implemented using any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

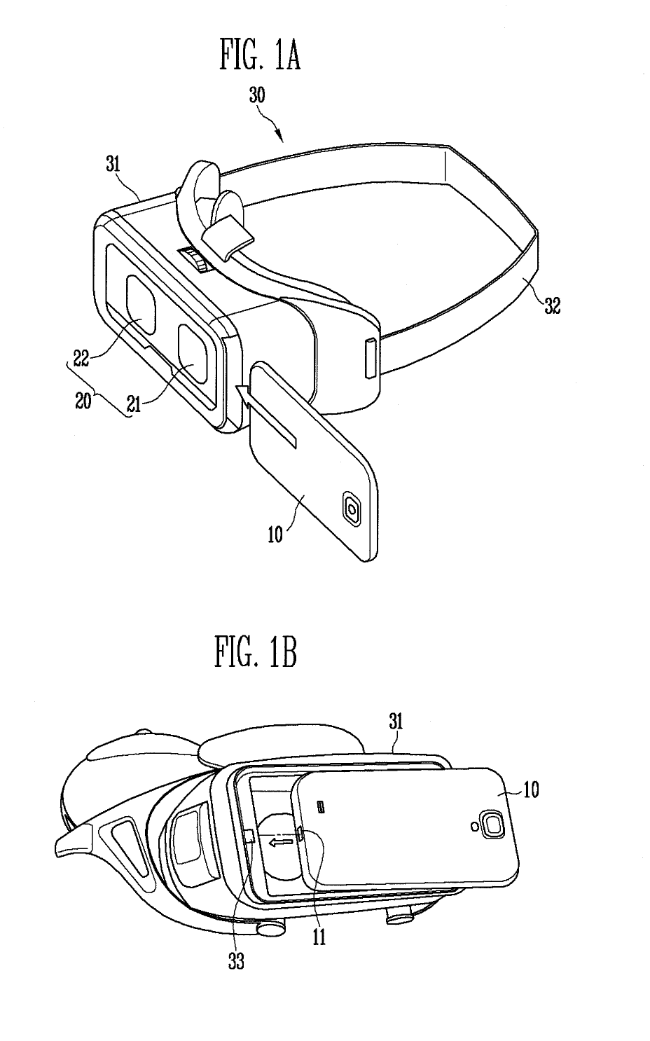

FIG. 1A to FIG. 1C illustrate a wearable device according to the present embodiment, and a state in which a display device is mounted to the wearable device. FIG. 1A to FIG. 1C illustrate a HMD as an example of the wearable device, but the wearable device according to the present invention is not limited thereto.

Referring to FIG. 1A and FIG. 1B, the wearable device 30 according to the present embodiment may include a frame 31. A band 32 may be connected to the frame 31, and a user may wear the frame 31 on the head by using the band 32. This frame 31 has a structure in which a display device 10 can be detachably mounted.

According to the present embodiment, the display device 10 that is mountable to the wearable device 30 may be a smart phone, or may be any electronic device such as a tablet PC, an electronic book reader, a computer, a workstation, a personal digital assistant (PDA), a potable multimedia player (PMP), a camera, and the like, which can be mounted to the wearable device 30 and includes a display unit.

According to the present embodiment, when the display device 10 is mounted to the frame 31, a connection portion 11 of the display device 10 may be electrically coupled to a connection portion 33 of the frame 31. Accordingly, communications between the wearable device 30 and the display device 10 may be performed. The wearable device 30 may include at least one of a touch sensor, a button, and a wheel key, to control the display device 10 mounted to the frame 31.

When the display device 10 is mounted to the wearable device 30, the display device 10 may be operated as a HMD. For example, the display device 10 may be driven in a first mode when separated from the wearable device 30, and may be driven in a second mode for displaying an effective image at a region that is different from a region used in the first mode when the display device 10 is mounted to the wearable device 30. According to the present embodiment, the first mode may be a general display mode (e.g., normal mode) for displaying an image at the entire display area of the display device 10, and the second mode may be a partial display mode (e.g., VR mode) for displaying an image at a portion of the display area of the display device 10.

According to the present embodiment, a driving mode of the display device 10 can be switched automatically or manually. For example, when the display device 10 is mounted to the wearable device 30, the driving mode of the display device 10 may be automatically switched to the second mode, or may be switched to the second mode by a setting of the user. When the display device 10 is separated from the wearable device 30, the driving mode of the display device 10 may be automatically switched to the first mode, or may be switched to the first mode by the setting of the user

According to the present embodiment, the wearable device 30 may include a lens 20 corresponding to two eyes of the users. For example, the wearable device 30 may include a left eye lens 21 and a right eye lens 22 corresponding to a left eye and a right eye of the user, respectively. However, the present invention is not limited to the wearable device 30 including the left eye lens 21 and the right eye lens 22. For example, a wearable device 30 according to another embodiment may include an integrated lens 20 to allow the user to concurrently or simultaneously watch a same image by using the left eye and the right eye. According to the present embodiment, the lens 20 may be, but is not limited to, a fisheye lens, a wide-angle lens, or the like, to enhance a user's field of view (FOV).

When the display device 10 is fixed to the frame 31, the user can watch an image displayed on the display device 10 through the lens 20. As a result, it is possible to accomplish an effect of watching a video with a large screen at a certain distance.

Referring to FIG. 1C, when the display device 10 is mounted to the wearable device 30, some regions of the display device 10 can be blocked by the frame 31. For example, when the display device 10 is mounted on the wearable device 30, a portion of the display area of the display device 10 may be covered by the frame 31.

As an example, in a state in which the display device 10 is mounted to the wearable device 30, a central portion including a region of the display area of the display device 10 that is viewed by a user through the lens 20 of the wearable device 30 may be a visible display area VDA. A remaining display area (e.g., an outer portion of the display area) of the display device 10 may be a non-visible display area NVDA that is covered by the frame 31.

According to the present embodiment, a central portion of the display device 10 may be divided into a visible display area VDA and a non-visible display area NVDA such that a more vivid image can be displayed to the user. For example, portions of the display device 10 corresponding to the left eye lens 21 and the right eye lens 22 may be set as the visible display area VDA, and the remaining portions may be set as the non-visible display area NVDA. In this case, 3D images may be displayed by controlling images displayed in the visible display area VDA to correspond to the left eye lens 21 and the right eye lens 22.

When the display device 10 mounted to the wearable device 30 is driven in the second mode, effective images may be displayed in the central portion that is the visible display area VDA. No image might be displayed in the non-visible display area NVDA, or black or dummy images may be displayed therein instead.

When the display device 10 is separated from the wearable device 30 and is driven in the first mode, the entire display area of the display device 10 may be visible to the user. In other words, when the display device 10 is separated from the wearable device 30, the entire display area may be the visible display area VDA. In this case, in the display device 10, effective images may be displayed in the entire display area.

In other words, the display device 10 according to the present embodiment may be driven differently depending on whether it is in the first mode or the second mode, which are different from each other. For example, the display device 10 may differently display effective images at a one or more regions depending on the mode selected.

As in the present embodiment, in the case of using the display device 10 together with the wearable device 30, various forms of images may be displayed. However, a first region where effective images are displayed when the display device 10 is driven in the first mode is different from a second region where effective images are displayed when the display device 10 is driven in the second mode. Accordingly, a boundary line between the visible display area VDA and the non-visible display area NVDA may be visible when the driving mode of the display device 10 is switched.

For example, when it is assumed that images are displayed only in the visible display area VDA of the central portion during a period in which the display device 10 is driven in the second mode, and that the driving of the non-visible display area NVDA is stopped, hysteresis or characteristics of driving transistors included in pixels of the visible display area VDA may be different from that of driving transistors included in pixels of the non-visible display area NVDA. Accordingly, when the display device 10 is switched from the second mode to the first mode after the display device 10 is driven in the second mode, luminance deviation may occur between the visible display area VDA during the second mode and the non-visible display area NVDA so that a boundary therebetween may be visible.

Therefore, an embodiment of the present invention suggests a display device and a driving method thereof, which are capable of not only reducing or preventing a boundary between a plurality of regions constituting the display area from being visible, but also capable of displaying effective images having uniform luminance.

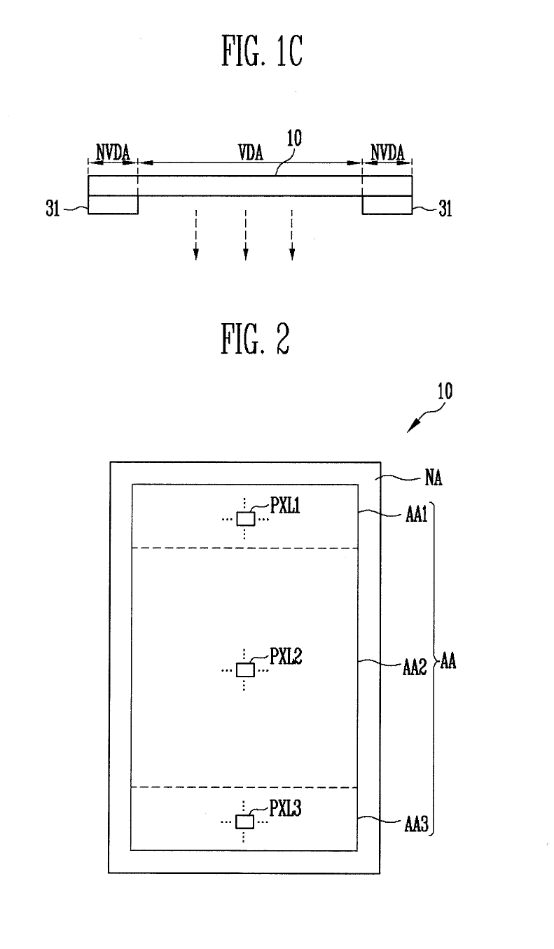

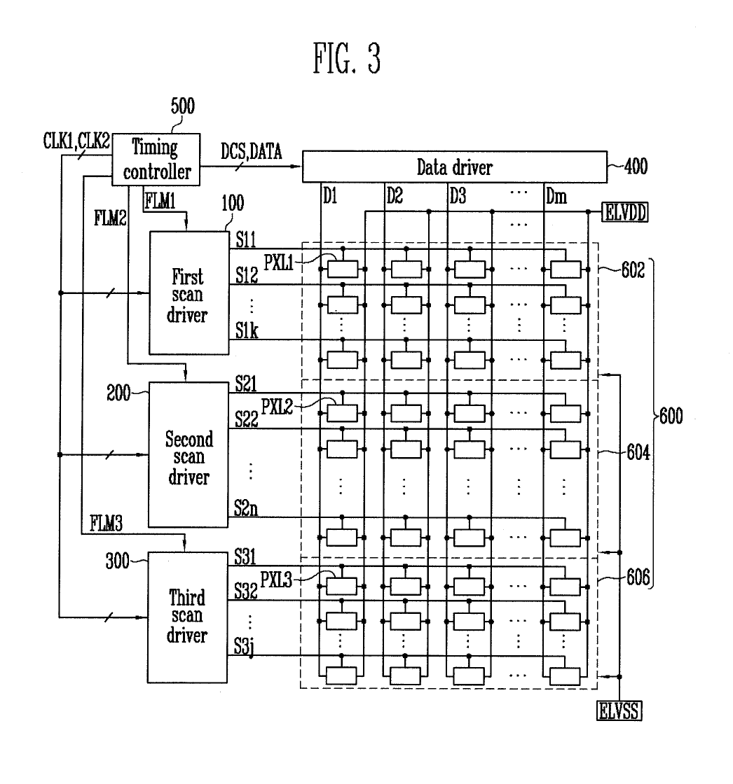

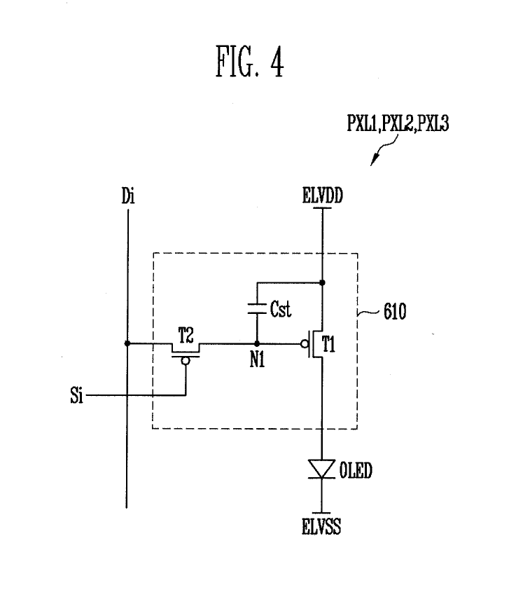

FIG. 2 schematically illustrates a display device according to the present embodiment.

Referring to FIG. 2, the display device 10 according to the present embodiment includes a display area AA and a peripheral area NA. According to the present embodiment, the display area AA may include a plurality of pixels PXL1, PXL2, and PXL3 to serve as an active area for displaying images. The peripheral area NA may be regions other than the display area AA (e.g., a non-active area positioned around the display area AA).

The display area AA may include at least two pixel areas AA1, AA2, and AA3 adjacently arranged. For example, the display area AA may include first, second and third pixel areas AA1, AA2, and AA3, which are arranged sequentially and/or continuously from one side of the display device 10. A plurality of pixels PXL1, PXL2, and PXL3 may be respectively provided in each of the pixel areas AA1, AA2, and AA3.

These pixels PXL1, PXL2, and PXL3 may be used to display images in the display area AA.

According to the present embodiment, the first pixel area AA1 may be positioned at a first side of the second pixel area AA2, and the third pixel area AA3 may be positioned at a second side of the second pixel area AA2. As an example, the first and third pixel areas AA1 and AA3 may be respectively positioned at opposite sides of the second pixel area AA2. For example, the first pixel area AA1 may be positioned at an upper side of the second pixel area AA2, and the third pixel area AA3 may be positioned at a lower side of the second pixel area AA2. In this case, the second pixel area AA2 may be positioned between the first and third pixel areas AA1 and AA3.

According to the present embodiment, at least two of the pixel areas AA1, AA2, and AA3 may have different area. For example, the second pixel area AA2 may have an area that is larger than those of the first pixel area AA1 and/or the third pixel area AA3. For example, the second pixel area AA2 may have a largest area, and the first pixel area AA1 and the third pixel area AA3 may have areas of the same size. In this case, a large number of scan lines may be located in the second pixel area AA2 as compared to the first and third pixel areas AA1 and AA3. However, the present invention is not limited thereto. For example, in another embodiment, the pixel areas AA1, AA2, and AA3 may be set to have areas of the same size.

In addition, according to the present embodiment, it is illustrated in FIG. 2 that the first pixel area AA1, the second pixel area AA2, and the third pixel area AA3 have a same width, but the present invention is not limited thereto. For example, the first pixel area AA1 and/or the third pixel area AA3 may have a shape that gradually narrows in width as a distance from the second pixel area AA2 increases. Alternatively, the first pixel area AA1 and/or the third pixel area AA3 may have a certain width, which is narrower than the width of the second pixel area AA2.

In addition, according to the present embodiment, at least two of the pixel areas AA1, AA2, and AA3 may have a same width and/or length, or may have a same number of horizontal pixel columns and/or a same number of scan lines, but they may have differently sized areas. For example, the first pixel area AA1 and the third pixel area AA3 may have a same number of horizontal pixel lines and/or a same number of scan lines as the same width and/or length, and their areas may be different. As an example, although the first pixel area AA1 and the third pixel area AA3 have a substantially same width and/or length, when a concave portion, an opening portion, or a dummy area (an area where first-group pixels PXL1 are not provided) or the like is positioned in one region of the first pixel region AA1, the effective area of the first pixel area AA1 may be smaller than that of the third pixel area AA3. As a result, in the present embodiment, the shape and size (e.g., width, length, and/or area) of the first pixel area AA1, the second pixel area AA2, and/or the third pixel area AA3 are not particularly limited, and may be variously modified.

According to the present embodiment, the second pixel area AA2 positioned at a central portion of the display area AA may correspond to the visible display area VDA illustrated in FIG. 1C. The first pixel area AA1 and third pixel area AA3 positioned at an edge of the display area AA may correspond to the non-visible display area NVDA illustrated in FIG. 1C.

For example, when the display device 10 is driven in the second mode, the user might not watch an image displayed in the first pixel area AA1 and the third pixel area AA3, but may watch only an image displayed in the second pixel area AA2. In this case, the display device 10 can display an effective image only in the second pixel area AA2.

When the display device 10 is driven in the first mode, the user may watch images displayed in the first to third pixel areas AA1, AA2, and AA3. In other words, when the display device 10 is driven in the first mode, effective images may be displayed in the entire display area AA including the first to third pixel area AA1, AA2, and AA3. As an example, when the display device 10 is driven in the first mode, a single screen may be implemented in the entire display area AA by connecting images displayed in the first to third pixel areas AA1, AA2, and AA3.

According to the present embodiment, a plurality of first-group pixels PXL1 may be provided in the first pixel area AA1, and a plurality of second-group pixels PXL2 may be provided in the second pixel area AA2. A plurality of third-group pixels PXL3 may be provided in the third pixel area AA3.

The pixels PXL1, PXL2, and PXL3 emit light (e.g., at a predetermined luminance) corresponding to various driving power supplies and/or driving signals supplied from the drivers. To this end, each of the pixels PXL1, PXL2, PXL3 may include at least one light emitting element (e.g., an organic light emitting diode).

The peripheral area NA may be a non-display area in which an image is not displayed. Constituent elements for driving the pixels PXL1, PXL2, and PXL3 may be located in the peripheral area NA. For example, wires, pads and/or at least one driver may be located in the peripheral area NA.

According to the present embodiment, the peripheral area NA may be located around the display area AA to surround at least a portion of the display area AA. For example, the peripheral area NA may be located to surround the display area AA entirely outside the pixel areas AA1, AA2 and AA3 constituting the display area AA.

FIG. 3 illustrates a display device according to the present embodiment. According to the present embodiment, as shown in FIG. 1A to FIG. 2, the display device illustrated in FIG. 3 may be having a plurality of pixel areas, and may be detachable from the wearable device. For example, when mounted to the wearable device, the display device according to the embodiment of FIG. 3 may be driven in the second mode in which an effective image is displayed at a portion of the display device, and may be driven in the first mode in which an effective image is displayed in the entire display area.

Referring to FIG. 3, the display device according to the present embodiment includes a first scan driver 100, a second scan driver 200, a third scan driver 300, a data driver 400, a timing controller 500, and a display area 600.

The display area 600 includes at least two pixel areas 602, 604, and 606. For example, the display area 600 may include a first pixel area 602, a second pixel area 604, and a third pixel area 606.

According to the present embodiment, the first pixel area 602, the second pixel area 604, and the third pixel area 606 may be contiguously arranged to be respectively adjacent to each other. For example, the first pixel area 602, second pixel area 604 and third pixel area 606 may be sequentially arranged in that order from a side (e.g., upper end) of the display area 600. In this case, the second pixel area 604 may include a central portion of the display area 600. The first pixel area 602 may be positioned adjacent to a first horizontal line of the second pixel area 604, and the third pixel area 606 may be positioned adjacent to a last horizontal line of the second pixel area 604. Accordingly, a first second-group scan line S21 of second-group scan lines S21 to S2n (n is a natural number that is equal to or greater than 2) may be located to be adjacent to the last first-group scan line S1k (k is a natural number that is equal to or greater than 2), and the last second scan line S2n may be located to be adjacent to a first third-group scan line S31.

In the present embodiment, the display area 600 can display effective images in different areas corresponding to a plurality of different modes. For example, the display area 600 can display effective images in the entire area including the first to third pixel areas 602, 604, and 606 to correspond to the first mode (e.g., normal mode). In other words, when the display device is driven in the first mode, a predetermined effective image may be displayed in the first pixel area 602, the second pixel area 604, and the third pixel area 606. For example, when the display device is driven in the first mode, a single screen may be implemented by respective images connected to each other in the first to third pixel areas 602, 604, and 606 (e.g., to form a composite image). In this case, a user can watch images displayed in the first pixel area 602, the second pixel area 604, and the third pixel area 606.

In contrast, the display area 600 can display effective images in some areas to correspond to the second mode (e.g., a virtual reality/VR mode). For example, when the display device is driven in the second mode, effective images may be displayed only in the second pixel area 604 including a central portion corresponding to the lens 20 illustrated in FIG. 1A, for example. In addition, according to the present embodiment, when the display device is driven second mode, the first and third pixel areas AA1 and AA3 may display a dummy image, or their emission may be blocked by a light-emission control signal. According to the present embodiment, the dummy image may be changed at a higher speed than the effective image displayed in the second pixel area AA2, or may be a non-effective image that is difficult to be clearly recognized. In addition, the dummy image may be hidden in the frame 31, and thus not be visible to the user.

In a comparative embodiment, the driving of the first and third pixel areas 602 and 606 may be stopped during a period in which the display device is driven in the second mode. For example, no scan signal may be supplied to the first and third-group scan lines S11 to S1k and S31 to S3j connected to the first and third-group pixels PXL1 and PXL3 for the period in which the display device is driven in the second mode. In this case, no data signal is supplied to the first and third-group pixels PXL1 and PXL3.

However, when no data signal is supplied to the first and third-group pixels PXL1 and PXL3 to correspond to a specific mode (e.g., second mode), characteristic deviation may occur between driving transistors included in the first and third-group pixels PXL1 and PXL3 and driving transistors included in the second-group pixels PXL2 of the second pixel area 604. Accordingly, when the driving mode of the display device is switched from the second mode to the first mode, a luminance deviation may occur for each of the pixel areas 602, 604, and 606. Due to the luminance deviation, a boundary line may occur between the pixel areas 602, 604, and 606 in the display area 600, and the pixel areas 602, 604, and 606 may be, for example, recognized by the user as stains in the form of blocks.

In contrast, in the present embodiment, even when the display device is driven in the second mode, the data signal is supplied to the first and third-group pixels PXL1 and PXL3 by driving the first and third-group scan lines S11 to S1k and S31 to S3j. Accordingly, it is possible to prevent characteristics of the pixels PXL1, PXL2, and PXL3 from being set differently between the pixel areas 602, 604, and 606. Accordingly, according to the present embodiment, when the display device is driven in the first mode, the pixel areas 602, 604, and 606 may be prevented from being viewed by the user as block-like stains to improve display quality.

The first-group pixels PXL1 are provided in the first pixel area 602. The first-group pixels PXL1 are connected to the first-group scan lines S11 to S1k and the data lines D1 to Dm. According to the present embodiment, the first-group scan lines S11 to S1k may be provided in the first pixel area 602 extending along a first direction (e.g., a horizontal direction). According to the present embodiment, the data lines D1 to Dm may be provided to the display area 600 in a second direction (e.g., in a vertical direction) that crosses the first-group scan lines S11 to S1k to cross the first to third-group scan lines S11 to S1k, S21 to S2n, and S31 to S3j.

When a first scan signal is supplied to the first-group scan lines S11 to S1k, the first-group pixels PXL1 are selected to receive a data signal from the data lines D1 to Dm. The first-group pixels PXL1 receiving the data signal emit light with luminance corresponding to the data signal while controlling a driving current flowing to a second power supply ELVSS from a first power supply ELVDD via an organic light emitting diode.

The second-group pixels PXL2 are provided in the second pixel area 604. The second-group pixels PXL2 are connected to the second-group scan lines S21 to S2n and the data lines D1 to Dm. According to the present embodiment, the second-group scan lines S21 to S2n may be provided in the second pixel area 604 extending the first direction (e.g., the horizontal direction) to cross the data lines D1 to Dm. According to the present embodiment, a number of the second-group scan lines S21 to S2n located in the second pixel area 604 may be greater than a number(s) of the first and/or the third-group scan lines S11 to S1k and S31 to S3j, (j is a natural number of 2 or more). For example, a number of the second-group scan lines S21 to S2n may be equal to, or greater than, a total number of the first and third-group scan lines S11 to S1k and S31 to S3j (e.g., n is a natural number equal to or greater than k+j).

When a second scan signal is supplied to the second-group scan lines S21 to S2n, the second-group pixels PXL2 are selected to receive the data signal from the data lines D1 to Dm. The second-group pixels PXL2 receiving the data signal emit light with luminance corresponding to the data signal while controlling a driving current flowing to the second power supply ELVSS from the first power supply ELVDD via the organic light emitting diode.

The third-group pixels PXL3 are provided in the third pixel area 606. The third-group pixels PXL3 are connected to the third-group scan lines S31 to S3j and the data lines D1 to Dm. According to the present embodiment, the third-group scan lines S31 to S3j may be provided in the third pixel area 606 in a form extending the first direction (e.g., the horizontal direction) to cross the data lines D1 to Dm.

When a third scan signal is supplied to the third-group scan lines S31 to S3j, the third-group pixels PXL3 are selected to receive the data signal from the data lines D1 to Dm. The third-group pixels PXL3 receiving the data signal emit light with luminance corresponding to the data signal while controlling a driving current flowing to the second power supply ELVSS from the first power supply ELVDD via the organic light emitting diode.

Meanwhile, in the present embodiment, the first to third-group pixels PXL1, PXL2, and PXL3 may be implemented with various types of circuits. For example, the first to third-group pixels PXL1, PXL2, and PXL3 may include various pixel circuits including a driving transistor.

In addition, a number of the first, second, and/or third-group scan lines S11 to S1k, S21 to S2n, and S31 to S3j positioned in the first, second, and/or third pixel areas 602, 604, and 606 may be variously changed. For example, a number of the first-group scan lines S11 to S1k may be set to at least two or more in consideration of a region overlapping with the frame 31 of the wearable device 30. For example, more than one hundred first-group scan lines S11 to S1k may be arranged in the first pixel area 602. Similarly, a number of the third-group scan lines S31 to S3j may be set to at least two or more in consideration of a region overlapping with the frame 31 of the wearable device 30. For example, more than one hundred third-group scan lines S31 to S3j may be arranged in the third pixel area 606. In contrast, a number of the second-group scan lines S21 to S2n may be set to at least two or more in consideration of a region overlapping with the lens 20 of the wearable device 30. For example, more than two hundred second-group scan lines S21 to S2n may be arranged in the second pixel area 604.

The first scan driver 100 drives the first-group scan lines S11 to S1k by supplying the first scan signal to the first-group scan lines S11 to S1k. When the first scan signal is supplied to the first-group scan lines S11 to S1k, the first-group pixels PXL1 are sequentially selected in a unit of horizontal lines. For this purpose, the first scan signal is set as a gate-on voltage capable of turning on a transistor (e.g., a switching transistor) included in the first-group pixels PXL1.

The second scan driver 200 drives the second-group scan lines S21 to S2n by supplying the second scan signal to the second-group scan lines S21 to S2n. When the second scan signal is supplied to the second-group scan lines S21 to S2n, the second-group pixels PXL2 are sequentially selected in horizontal line units. For this purpose, the second scan signal is set as a gate-on voltage capable of turning on a transistor (e.g., a switching transistor) included in the second-group pixels PXL2.

The third scan driver 300 drives the third-group scan lines S31 to S3j by supplying the third scan signal to the third-group scan lines S31 to S3j. When the third scan signal is supplied to the third-group scan lines S31 to S3j, the third-group pixels PXL3 are sequentially selected in units of horizontal lines. For this purpose, the third scan signal is set as a gate-on voltage capable of turning on a transistor (e.g., a switching transistor) included in the third-group pixels PXL3.

The data driver 400 receives a data control signal DCS and an image data DATA from the timing controller 500. The data driver 400 generates data signals to correspond to the data control signal DCS and the image data DATA, and supplies the generated data signals to the data lines D1 to Dm.

When the display device is driven in the first mode, the first scan driver 100, the second scan driver 200, and the third scan driver 300 may sequentially drive the first, second, and third-group scan lines S11 to S1k, S21 to S2n, and S31 to S3j during each frame period. For example, the first scan driver 100, the second scan driver 200, and the third scan driver 300 may sequentially scan the first pixel area AA1, the second pixel area AA2, and the third pixel area AA3 during each frame period according to the first mode. Then, the data signal from the data driver 400 may be sequentially supplied to the first-group pixels PXL1, the second-group pixels PXL2, and the third-group pixels PXL3 in the order of the first pixel area AA1, the second pixel area AA2, and the third pixel area AA3. Accordingly, an effective image may be displayed in the entire display area 600.

When the display device is driven in the second mode, the second scan driver 200 may sequentially drive the second-group scan lines S21 to S2n during each frame period. For example, the second scan driver 200 may scan the second pixel area 604 by sequentially supplying the second scan signal to the second-group scan lines S21 to S2n during each frame period according to the second mode. As the second pixel area 604 is scanned, the data signal from the data driver 400 is sequentially supplied to the second-group pixels PXL2 of each horizontal line. Accordingly, an effective image may be displayed only in the second pixel area 604.

However, in the present embodiment, when the display device is driven in the second mode, the first and third pixel areas 602 and 606 are alternately scanned while the second pixel area 604 is scanned during each frame period. For example, in the present embodiment, when the display device is driven in the second mode, the first pixel area 602 and the third pixel area 606 are alternately scanned until the second pixel area 604 is completely scanned.

For example, when k first-group scan lines S11 to S1k, n second-group scan lines S21 to S2n, and j third-group scan lines S31 to S3j are respectively located in the first pixel area 602, the second pixel area 604, and the third pixel area 606, the first and second scan drivers 100 and 200 may concurrently or simultaneously supply scan signals to a first first-group scan line S11 of the first pixel area 602 and to a first second-group scan line S21 of the second pixel area 604 during a first horizontal period of each frame period. The first and second scan drivers 100 and 200 may sequentially respectively supply the scan signals to second to k^{th} first-group scan lines S12 to S1k and second to k^{th} second-group scan lines S22 to S2k during second to k^{th} horizontal periods by sequentially shifting the scan signals supplied to the first first-group scan line S11 and the first second-group scan line S21.

After the supply of scan signals to k first-group scan lines S11 to S1k and k second-group scan lines S21 to S2k is completed, the second and third scan drivers 200 and 300 may concurrently or simultaneously supply scan signals to a (k+1)^{th} second scan line S(2k+1) of the second pixel area 604 and a first third-group scan line S31 of the third pixel area 606 during a following period (e.g., during a (k+1)^{th} horizontal period) of each frame period. Next, the second and third scan driver 200 and 300 may sequentially supply scan signals to (k+2)^{th} to (k+j)^{th} second-group scan lines S(2k+2) to S(2k+j) and to second to j^{th} third-group scan lines S32 to S3j during (k+2)^{th} (k+j)^{th} horizontal periods.

For example, according to the present embodiment, the second scan driver 200 sequentially drives the second-group scan lines S21 to S2n to correspond to the second mode during the frame period, and the first and third scan drivers 100 and 300 alternately drive the first and third-group scan lines S11 to S1k and S31 to S3j during periods in which the second-group scan lines S21 to S2n are driven. To that end, the first, second, and third scan drivers 100, 200, and 300 may respectively receive first, second and third start signals FLM1, FLM2, and FLM3 to be differently driven depending on the driving mode of the display device.

According to the present embodiment, when the display device is driven in the second mode, the first and third-group scan lines S11 to S1k and S31 to S3j of the first and third pixel areas 602 and 606, which are set as the non-visible display area NVDA, are driven together with the second-group scan lines S21 to S2n of the second pixel area 604, which is set as the visible display area VDA. In other words, in the present embodiment, even when the display device is driven in the second mode, all of the first to third-group pixels PXL1, PXL2, and PXL3 are driven.

Accordingly, it is possible to prevent characteristics of the driving transistors included in the pixels PXL1, PXL2, and PXL3 from being differently set between the pixel areas 602, 604, and 606 while acquiring a time suitable for the driving. Thus, when the driving mode of the display device is switched from the second mode to the first mode, the pixel areas 602, 604, and 606 may be prevented from being visible to the user as block-like stains by suppressing occurrence of boundary lines between the pixel areas 602, 604, and 606 in the display area 600.

In addition, in the present embodiment, the first and third scan drivers 100 and 300 repeatedly sequentially drive the first and third-group scan lines S11 to S1k and S31 to S3j until sequential driving of the second-group scan lines S21 to S2n is completed during each frame period. In this case, at least one of the first and third scan drivers 100 and 300 may repeatedly drive at least some of the first and third-group scan lines S11 to S1k and S31 to S3j more than once during one frame period in correspondence to the second mode. Accordingly, in the present embodiment, even when the display device is driven in the second mode, the scan signals may be supplied to a same number of scan lines (e.g., two of the first to third-group scan lines S11 to S1k, S21 to S2n, and S31 to S3j) during each of a plurality of horizontal periods constituting one frame.

According to the present embodiment, a driving load (e.g., a clock load CLK load), is uniformly applied to the scan drivers 100, 200, and 300 during each frame period. Accordingly, an effective image of uniform luminance may be displayed in the display area 600 irrespective of an area where the effective image is displayed ad irrespective of the driving mode. Thus, according to the present embodiment, it is possible to improve display quality of the display device.

The timing controller 500 generates clock signals CLK1 and CLK2, start signals FLM1, FLM2, and FLM3, and a data control signal DCS, based on externally supplied timing signals. The clock signals CLK1 and CLK2 generated in the timing controller 500 are supplied to the first scan driver 100, the second scan driver 200, and the third scan driver 300. The first start signal FLM1, the second start signal FLM2, and the third start signal FLM3 generated in the timing controller 500 are respectively supplied to the first scan driver 100, the second scan driver 200, and the third scan driver 300. In addition, the data control signal DCS generated in the timing controller 500 is supplied to the data driver 400.

The first start signal FLM1 controls supply times of the first scan signals. The clock signals CLK1 and CLK2 supplied to the first scan driver 100 are used to shift the first start signal FLM1.

The second start signal FLM2 controls supply times of the second scan signals. The clock signals CLK1 and CLK2 supplied to the second scan driver 200 are used to shift the second start signal FLM2

The third start signal FLM3 controls supply times of the third scan signals. The clock signals CLK1 and CLK2 supplied to the third scan driver 300 are used to shift the third start signal FLM3.

The data control signal DCS includes a source start signal, a source output enable signal, and a source sampling clock. The source start signal controls a data sampling starting point of the data driver 400. The source sampling clock controls a sampling operation of the data driver 400 based on a rising time or a falling time. The source output enable signal controls an output time of the data driver 400.

In addition, the timing controller 500 rearranges the image data DATA and transmits it to the data driver 400. As an example, the timing controller 500 may convert the image data DATA to match an area (e.g., a predetermined area) in which the effective image is displayed corresponding to the first mode or the second mode, and may transmit it to the data driver 400. Alternatively, the timing controller 500 may receive the image data DATA to match the area in which the effective image is displayed from a host system or the like, and may arrange the image data DATA, and may then transmit the image data DATA to the data driver 400. Then, the data driver 400 generates a data signal corresponding to the image data DATA supplied from the timing controller 500.

As described above, the display device according to the present embodiment drives not only the second-group scan lines S21 to S2n of the visible display area VDA (e.g., the second pixel area 604) but also drives the first and third-group scan lines S11 to S1k and S31 to S3j of the non-visible display area NVDA (e.g., first and third pixel area 602 and 606) during a period in which the display device is driven in the second mode to display the effective image in only a portion of the display area 600. Thus, it is possible to prevent characteristics of the driving transistors included in the pixels PXL1, PXL2, and PXL3 from being set differently. In addition, the display device according to the present embodiment repeatedly alternately driving of the first-group scan lines S11 to S1k and the third-group scan lines S31 to S3j until sequential driving of the second-group scan lines S21 to S2n is completed during the period in which the display device is driven in the second mode. Accordingly, it is possible to display an effective image with uniform luminance.

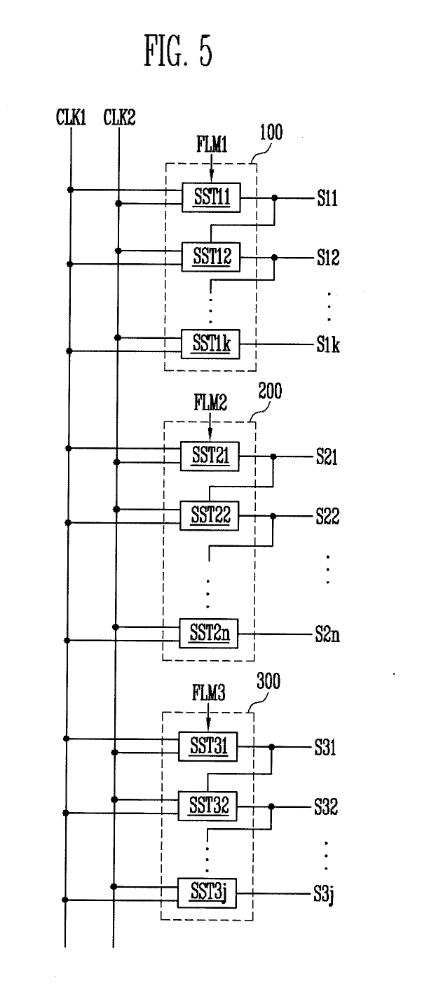

FIG. 4 illustrates an example of a pixel shown in FIG. 3. For convenience, one pixel (of the first to third-group pixels PXL1, PXL2, and PXL3) connected to an i^{th} data line Di (i is a natural number) and an i^{th} scan line Si (any one of the first-group scan lines S11 to S1k, the second-group scan lines S21 to S2n, and the third-group scan lines S31 to S3j) is illustrated in FIG. 4.

Referring to FIG. 4, according to the present embodiment, each of the pixels PXL1, PXL2, and PXL3 includes an organic light emitting diode OLED, and a pixel circuit 610 for controlling a driving current supplied to the organic light emitting diode OLED.

An anode of the organic light emitting diode OLED is connected to the pixel circuit 610, and a cathode thereof is connected to a second power supply ELVSS. This organic light emitting diode OLED generates light with predetermined luminance in response to the driving current supplied from the pixel circuit 610.

The pixel circuit 610 controls a current amount of the driving current flowing from the first power supply ELVDD to the second power supply ELVSS via the organic light emitting diode OLED in response to the data signal. For this purpose, the pixel circuit 610 includes a first transistor T1 and a second transistor T2.

The first transistor (driving transistor) T1 is connected between the first power supply ELVDD and the anode of the organic light emitting diode OLED. A gate electrode of the first transistor T1 is connected to a first node N1. This first transistor T1 controls a current amount of the driving current flowing from the first power supply ELVDD to the second power supply ELVSS via the organic light emitting diode OLED in response to a voltage of the first node N1.

The second transistor (switching transistor) T2 is connected between the data line Di and the first node N1. A gate electrode of the second transistor T2 is connected to the scan line Si. When the scan signal is supplied to the scan line Si, the second transistor T2 is turned on to electrically connect the data line Di and the first node N1.

The storage capacitor Cst is connected between the first power supply ELVDD and the first node N1. The storage capacitor Cst stores a voltage corresponding to the data signal.

An operation process of the pixels PXL1, PXL2, and PXL3 will be described. First, a scan signal is supplied to the scan line Si to turn on the second transistor T2. When the second transistor T2 is turned on, a data signal is supplied from the data line Di to the first node N1. In this case, the storage capacitor Cst stores a voltage corresponding to the data signal. The voltage corresponding to the data signal is stored in the storage capacitor Cst, and then the second transistor T2 is turned off.

Next, the first transistor T1 controls the driving current flowing from the first power supply ELVDD to the second power supply ELVSS via the organic light emitting diode OLED. Then, the organic light emitting diode OLED generates light with luminance corresponding to a current amount of the driving current. When a data signal corresponding to a black gray is supplied to the first node N1, the first transistor T1 blocks the supply of the driving current to the organic light emitting diode OLED. In this case, the organic light emitting diode OLED emits no light to thereby display a black gray.

The pixels PXL1, PXL2, and PXL3 display images in the display area 600. In addition, in the present embodiment, a circuit structure of the pixels PXL1, PXL2, and PXL3 are not limited to the embodiment shown in FIG. 4, and may be implemented in various types of circuit structures currently known

For example, each of the pixel PXL1, PXL2, and PXL3 may further include one or more transistors for controlling a light emission period corresponding to a light emission control signal.

FIG. 5 illustrates an example of scan drivers shown in FIG. 3. Although FIG. 5 discloses an embodiment in which scan drivers are driven by two clock signals, the present invention is not limited thereto. For example, a number and/or type of clock signals may be varied.

Referring to FIG. 5, the first scan driver 100 according to the present embodiment includes first-group scan stages SST11 to SST1k connected to the first-group scan lines S11 to S1k, respectively. According to the present embodiment, a number of the first-group scan stages SST11 to SST1k may be variously changed depending on a number of horizontal lines provided in the first pixel area 602.

The first-group scan stages SST11 to SST1k receive a first start signal FLM1 and clock signals CLK1 and CLK2 to sequentially supply a first scan signal to the first-group scan lines S11 to S1k in response to the first start signal FLM1. For example, the first first-group stage SST11 may supply the first scan signal to the first first-group scan line S11 in response to the first start signal FLM1. The other first-group scan stages SST12 to SST1k may supply the first scan signal to a first-group scan line (any one of S12 to S1k) connected thereto in correspondence with an output signal of a previous single stage (e.g., the first scan signal of the previous single stage). In this case, supply times of the first scan signals supplied to each of the first-group scan lines S11 to S1k may be determined to correspond to a supply time of the first start signal FLM1.

According to the present embodiment, the second scan driver 200 includes second-group scan stages SST21 to SST2n connected to the second-group scan lines S21 to S2n, respectively. The second-group scan stages SST21 to SST2n receive a second start signal FLM2 and clock signals CLK1 and CLK2 to sequentially supply a second scan signal to the second-group scan lines S21 to S2n in response to the second start signal FLM2. For example, the first second-group scan stage SST21 may supply the second scan signal to the first second-group scan line S21 in response to the second start signal FLM2. The other second-group scan stages SST22 to SST2n may supply the second scan signal to a second scan line (any one of S22 to S2k) connected thereto in correspondence with an output signal of a previous single stage (e.g., the second scan signal of the previous single stage). In this case, supply times of the second scan signals supplied to each of the second-group scan lines S21 to S2k may correspond to a supply time of the second start signal FLM2.

According to the present embodiment, third scan driver 300 includes third-group scan stages SST31 to SST3j connected to third-group scan lines S31 to S3j, respectively. According to the present embodiment, a number of the third-group scan stages SST31 to SST3k may be variously changed depending on a number of horizontal lines provided in the third pixel area 606.

The third-group scan stages SST31 to SST3j receive a third start signal FLM3 and clock signals CLK1 and CLK2 to sequentially supply a third scan signal to the third-group scan lines S31 to S3j in response to the third start signal FLM3. For example, the first third-group scan stage SST31 may supply the third scan signal to the first third-group scan line S31 in response to the third start signal FLM3. The other third-group scan stages SST32 to SST3j may supply the third scan signal to a third scan line (any one of S32 to S3k) that is respectively connected thereto in correspondence with an output signal of a respective previous stage (e.g., the third scan signal of the immediately prior stage).

In this case, supply times of the third scan signals supplied to each of the third-group scan lines S31 to S3k may correspond to a supply time of the third start signal FLM3.

In the present embodiment, a configuration of the scan stages SST11 to SST1k, SST21 to SST2n, and SST31 to SST3j is not particularly limited. That is, the scan stages SST11 to SST1k, SST21 to SST2n, and SST31 to SST3j may be implemented with various types of scan driving circuits currently known.

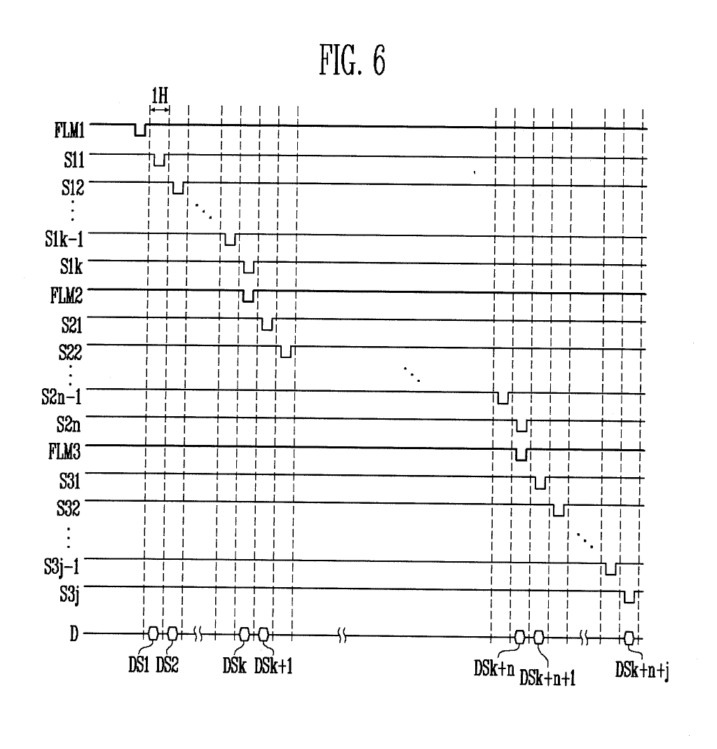

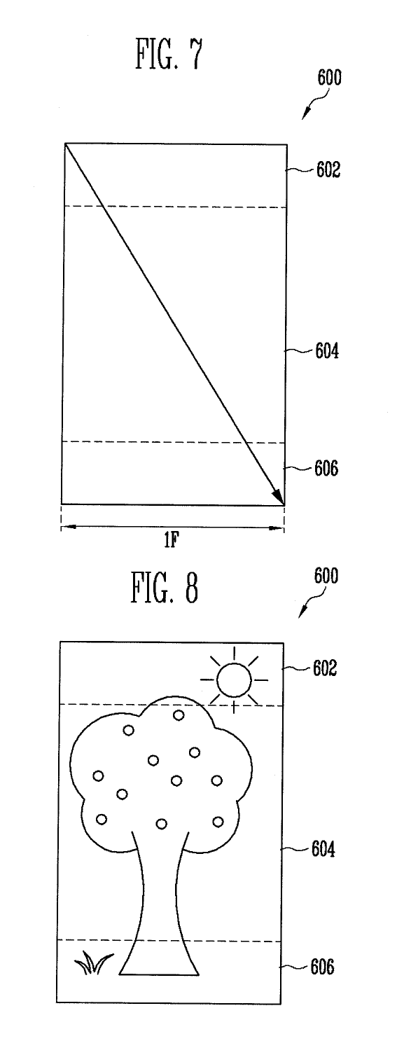

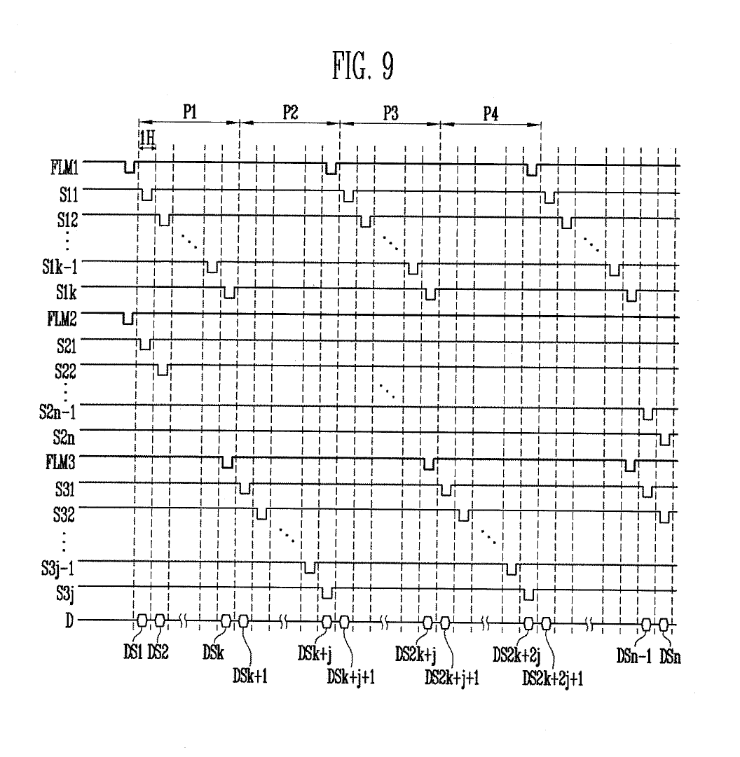

FIG. 6 illustrates an example of a driving timing of scan drivers when the display device shown in FIG. 3 is driven in a first mode. For example, FIG. 6 shows examples of start signals inputted to the scan driver during each frame period corresponding to the first mode and scan signals outputted from the scan drivers corresponding to the start signals. FIG. 7 schematically illustrates a supply order of scan signals supplied to a display area for a frame period when the display device shown in FIG. 3 is driven in the first mode, and FIG. 8 illustrates an example of an image that is displayed in a display area when the display device shown in FIG. 3 is driven in the first mode.

Referring to FIG. 6, when the display device is driven in the first mode, the timing controller 500 sequentially supplies the first start signal FLM1, the second start signal FLM2, and the third start signal FLM3 to the first scan driver 100, the second scan driver 200, and the third scan driver 300, respectively. Herein, supply times of the first start signal FLM1, the second start signal FLM2, and the third start signal FLM3 are set to sequentially supply the first scan signal, the second scan signal, and the third scan signal to the first-group scan lines S11 to S1k, the second-group scan lines S21 to S2n, and the third-group scan lines S31 to S3j, respectively. For example, the second start signal FLM2 may be supplied to overlap a last first scan signal supplied to the last first-group scan line S1k. Further, the third start signal FLM3 may be supplied to overlap the last second scan signal supplied to the last second scan line S2n. According to the present embodiment, the first start signal FLM1, the second start signal FLM2, and the third start signal FLM3 may have a same width, which may be varied.

When the first start signal FLM1 is supplied, the first scan driver 100 supplies a first first-group scan signal to the first-group scan line S11 in response to the clock signals CLK1 and CLK2. For example, the first scan driver 100 may supply the first first-group scan signal to the first-group scan line S11 by shifting the clock signals CLK1 and CLK2. In addition, the first scan driver 100 may supply a second first-group scan signal to the second first-group scan line S12 by shifting the first first-group scan signal. As described above, the first scan driver 100 sequentially supplies the first scan signal to the first-group scan lines S11 to S1k. Accordingly, data signals DS1 to DSk from the data driver 400 are supplied to the first pixel area 602. Accordingly, images corresponding to the data signals DS1 to DSk may be displayed in the first pixel area 602.

When the second start signal FLM2 is supplied, the second scan driver 200 supplies a first second-group scan signal to the first second-group scan line S21 in response to the clock signals CLK1 and CLK2. For example, the second scan driver 200 may supply the first second-group scan signal to the first second-group scan line S21 by shifting the second start signal FLM2 in response to the clock signals CLK1 and CLK2. In addition, the second scan driver 200 may supply the second second-group scan signal to the second second-group scan line S22 by shifting the first second-group scan signal. As described above, the second scan driver 200 sequentially supplies the second scan signal to the second-group scan lines S21 to S2n. Accordingly, data signals DSk+1 to DSk+n from the data driver 400 are supplied to the second pixel area 604, and thus images corresponding to the data signals DSk+1 to DSk+n may be displayed in the second pixel area 604.

When the third start signal FLM3 is supplied, the third scan driver 300 supplies a first third-group scan signal to the first third-group scan line S31 in response to the clock signals CLK1 and CLK2. For example, the third scan driver 300 may supply the first third-group scan signal to the first third-group scan line S31 by shifting the third start signal FLM3 in response to the clock signals CLK1 and CLK2. In addition, the third scan driver 300 may supply the second third-group scan signal to the second third-group scan line S32 by shifting the first third-group scan signal. As described above, the third scan driver 300 sequentially supplies the third scan signal to the third-group scan lines S31 to S3j. Accordingly, data signals DS(k+n+1) to DS(k+n+j) from the data driver 400 are supplied to the third pixel area 606, and thus images corresponding to the data signals DS(k+n+1) to DS(k+n+j) may be displayed in the third pixel area 606.

When the display device is driven in the first mode, the first, second, and third scan drivers 100, 200, and 300 sequentially supply the scan signals to all of the scan lines S11 to S1k, S21 to S2n, and S31 to S3j of the display area 600 by repeating the aforementioned process during each frame period. In other words, when the display device is driven in the first mode, the first, second, and third scan drivers 100, 200, and 300 sequentially drive the first, second, and third-group scan lines S11 to S1k, S21 to S2n, and S31 to S3j.

For example, when the display device is driven in the first mode, one frame period may be set to include a plurality of horizontal periods corresponding to a number (e.g., k+n+j) of the first to third-group scan lines S11 to S1k, S21 to S2n, and S31 to S3j. The scan signals may be supplied to all of the scan lines S11 to S1k, S21 to S2n and S31 to S3j once during each horizontal period 1H by sequentially driving the first to third-group scan lines S11 to S1k, S21 to S2n, and S31 to S3j during each frame period. Thus, data signals of the pixels may be supplied to the respective pixels PXL1, PXL2, and PXL3.

Accordingly, as shown in FIG. 7, the first pixels PXL1, the second pixels PXL2, and the third pixels PXL3 of each horizontal line may sequentially receive data signals by sequentially scanning the first pixel area 602, the second pixel area 604, and the third pixel area 606 during each frame period 1F.

As described above, when the display device is driven in the first mode, effective images may be displayed in the entire display area 600 of the display device. For example, as shown in FIG. 8, the effective images may be collectively displayed in all of the first pixel area 602, the second pixel area 604, and the third pixel area 606 constituting the display area 600. As an example, one connected screen may be implemented by connecting respective portions of images displayed in the first to third pixel area 602, 604, and 606.

According to the present embodiment, the first mode may be deactivated when the display device is mounted on the wearable device 30, and may be activated otherwise. In other words, the display device may be driven in the first mode when separated from the wearable device 30.

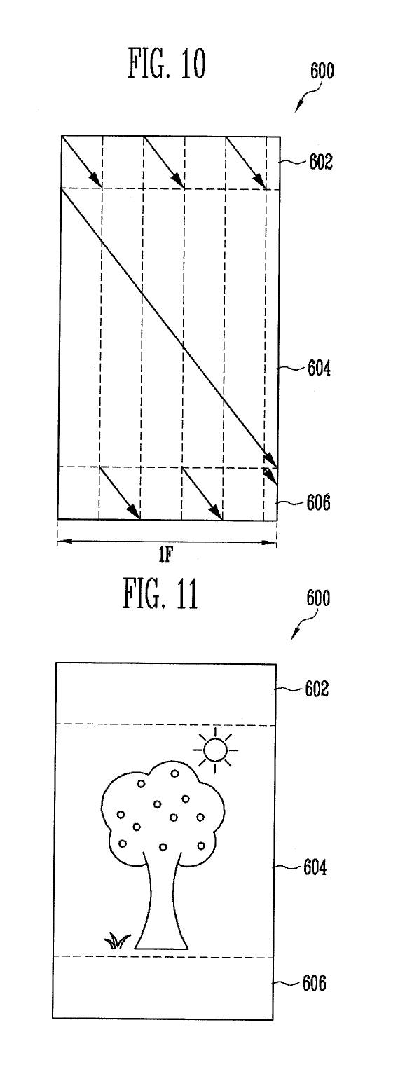

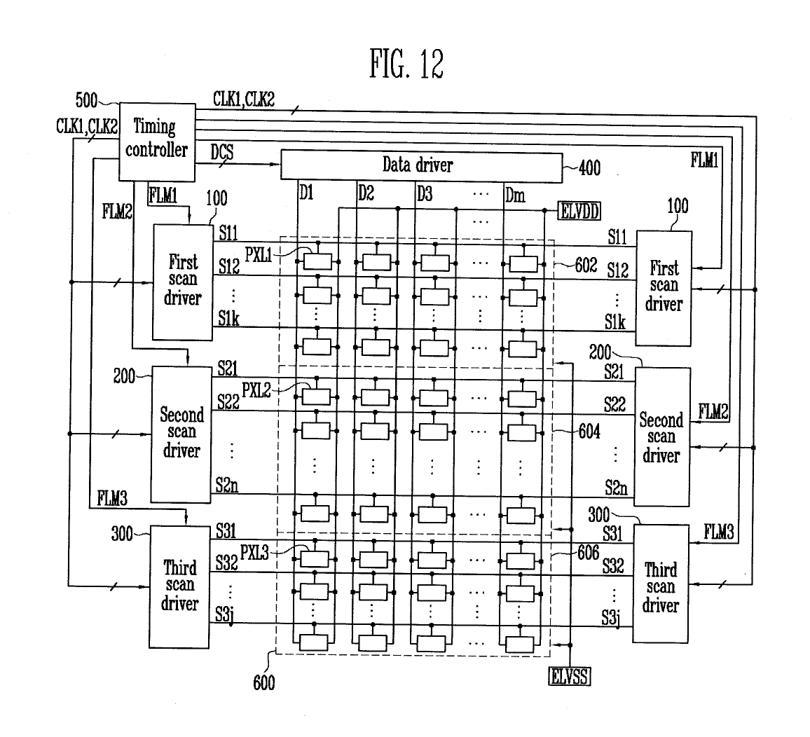

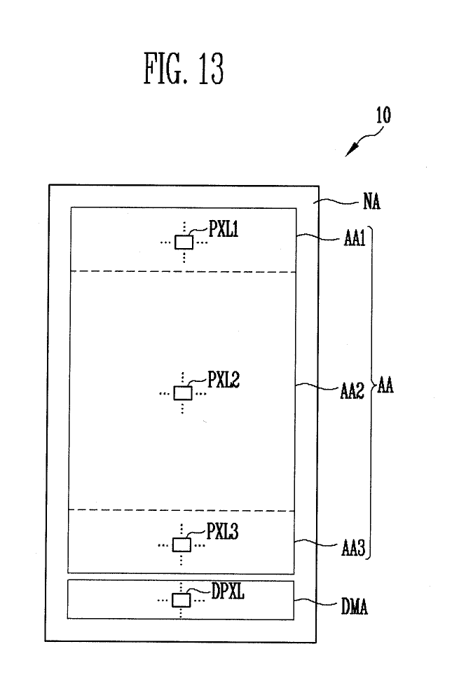

FIG. 9 illustrates an example of a driving timing of scan drivers when the display device shown in FIG. 3 is driven in a second mode. For example, FIG. 9 shows an example of start signals inputted to the scan drivers during each frame period, and scan signals outputted from the scan drivers corresponding to the start signals, corresponding to the second mode. FIG. 10 schematically illustrates a supply order of scan signals supplied to a display area for each frame period when the display device shown in FIG. 3 is driven in the second mode, and FIG. 11 illustrates an example of an image that is displayed in the display area when the display device shown in FIG. 3 is driven in the second mode.

Referring to FIG. 9, when the display device is driven in the second mode, the timing controller 500 respectively supplies the first start signal FLM1, the second start signal FLM2, and the third start signal FLM3 to the first scan driver 100, the second scan driver 200, and the third scan driver 300 (e.g., in a predetermined order). Herein, supply times of the first start signal FLM1, the second start signal FLM2, and the third start signal FLM3 are set such that the first-group scan lines S11 to S1k and the third-group scan lines S31 to S3j are driven during different portions of a period in which the second-group scan lines S21 to S2n are sequentially driven. For example, in the present embodiment, when the display device is driven in the second mode, supply times of the first start signal FLM1, the second start signal FLM2, and the third start signal FLM3 may be set such that the first pixel area 602 and the third pixel area 606 are repeatedly alternately scanned during the period in which the second pixel area 604 is scanned.

According to the present embodiment, the timing controller 500 may concurrently or simultaneously supply the first and second start signal FLM1 and FLM2 to the first and second scan drivers 100 and 200 in response to the second mode, and may supply the third start signal FLM3 to the third scan driver 300 in synchronization with the first scan signal when the first scan signal is supplied to the last first-group scan line S1k of the first-group scan lines S11 to S1k. In addition, in the case that sequential driving of the third-group scan lines S31 to S3j is completed while scanning the second pixel area 604, when the third scan signal is supplied to the last third-group scan line S3j, the first start signal FLM1 may be re-supplied, or again supplied, to the first scan driver 100 in synchronization with the third scan signal supplied to the last third-group scan line S3j.

For example, when the display device is driven in the second mode, one frame period may be set to include a plurality of horizontal periods corresponding to the number (e.g., n) of the second scan lines S21 to S2n. During each frame period, the second scan lines S21 to S2n may be sequentially driven one time, and the first-group scan lines S11 to S1k and the third-group scan lines S31 to S3j may be alternately and sequentially driven until sequential driving of the second-group scan lines S21 to S2n is completed.

For example, in response to the second mode, the second scan driver 200 may supply the second scan signal to any one of the second-group scan lines S21 to S2n during each horizontal period 1H, and the first and third scan drivers 100 and 300 may respectively supply the first or third scan signal to any one of the first-group scan lines S11 to S1k or any one of the third-group scan lines S31 to S3j during each of different ones of the horizontal periods 1H. In this case, the first or third scanning signal may be concurrently or simultaneously supplied so as to overlap any one second scanning signal during the corresponding horizontal period 1H.

For example, when one frame period includes first to fourth consecutive periods P1 to P4 that are sequentially arranged, the first scan driver 100 may sequentially drive the first-group scan lines S11 to S1k during first and third periods P1 and P3 of the period in which the second-group scan lines S21 to S2n are sequentially driven, and the third scan driver 300 may sequentially drive the third-group scan lines S31 to S3j during second and fourth periods P2 and P4 of the period in which the second-group scan lines S21 to S2n are sequentially driven.

In this case, k first-group scan lines S11 to S1k are sequentially driven, and k second-group scan lines (e.g., first to k^{th} second-group scan lines S21 to S2k) may be sequentially driven, during the first period P1. For example, the first scan signal and the second scan signal may be concurrently or simultaneously supplied to the first first-group scan line S11 and the first second-group scan line S21, and the first scan signal and the second scan signal may be concurrently or simultaneously supplied to the last/k^{th} first-group scan line S1k and the k^{th} second-group scan line S2k.

Next, j third-group scan lines S31 to S3j may be sequentially driven, and j second-group scan lines (e.g., (k+1)^{th} to (k+j)^{th} second-group scan lines S(2k+1) to S(2k+j)) may be sequentially driven, during the second period P2.

For example, the third scan signal and the second scan signal may be concurrently or simultaneously supplied to the first third-group scan line S31 and the (k+1)^{th} second scan line S(2k+1), and the third scan signal and the second scan signal may be concurrently or simultaneously supplied to the last/j^{th} third-group scan line S3j and the (k+j)^{th} second scan line S(2k+j).

As described above, k first-group scan lines S11 to S1k and k second-group scan lines S(2k+j+1) to S(2k+j+k) may be concurrently or simultaneously sequentially driven during the third period P3, and j third-group scan lines S31 to S3j and j second-group scan lines (S2k+j+k+1) to S(2k+j+k+j) may be concurrently or simultaneously sequentially driven during the fourth period P4.

When the second start signal FLM2 is supplied during each frame period of a period in which the second mode is executed, the second scan driver 200 may sequentially supply the second scan signal to the second-group scan lines S21 to S2n, and the data driver 400 outputs the data signals DS1 to DSn corresponding to effective images to be displayed in the second pixel area 604 in accordance with a driving time point of the second scan driver 200. In other words, the data driver 400 sequentially supplies the data signals DS1 to DSn corresponding to the first horizontal line to the last horizontal line of the second pixel area 604 during each frame period in response to the second mode. The data signals DS1 to DSn are supplied to the second pixel area 604 to correspond to each second-group scan signal. Accordingly, effective images corresponding to the data signals DS1 to DSn are displayed in the second pixel area 604.

When the display device is driven in the second mode, the first to third scan drivers 100, 200, and 300 supply the scan signals to the first to third-group scan lines 811 to S1k, S21 to S2n, and S31 to S3j while repeating the aforementioned process. In other words, when the display device is driven in the second mode, the second-group scan lines S21 to S2n are sequentially driven as shown in FIG. 10. The first-group scan lines S11 to S1k and the third-group scan lines S31 to S3j are alternately sequentially driven during different portions of the period in which the second-group scan lines S21 to S2n are driven.

According to the present embodiment, when the display device is driven in the second mode, effective images are displayed in some portions of the display area 600. For example, as shown in FIG. 11, the effective images might be displayed only in the second pixel area 604 in response to the second mode in the display area 600.

According to the present embodiment, the second mode can be activated when the display device is mounted on the wearable device 30 covering the first and third pixel areas 602 and 606. For example, when the display device is mounted in the wearable device 30, the first and third pixel areas 602 and 606 may be covered by the frame 31 and the like to serve as the non-visible display area NVDA, and at least a portion of the second pixel area 604 may serve as the visible display area VDA that is visible to the user. Accordingly, although the first and third pixel areas 602 and 606 receive some of the data signals supplied to the second display area 604 while being driven with a frequency that is quicker than that of the second pixel area 604, a dummy image or the like displayed in the first and third pixel areas 602 and 606 might not interfere with viewing of the effective images displayed in the second pixel area 604.

According to the present embodiment, when the display device is driven in the second mode, the effective images displayed in the second pixel area 604 may be divided into a plurality of images

For example, when the display device is mounted to the wearable device 30 including the left eye lens 21 and the right eye lens 22 to be driven, as shown in FIG. 1A to FIG. 1C, the second pixel area 604 may be divided into a plurality of regions to correspond to the left eye lens 21 and the right eye lens 22, and effective images may be displayed in each of the separate regions. For example, the second pixel area 604 may be divided into a plurality of regions including a left eye region for displaying a left eye image and a right eye region for displaying a right eye image to respectively supply data signals corresponding to the left eye image and right eye image to the left eye region and the right eye region, respectively.

As described above, according to the present embodiment, even when the display device is driven in the second mode, a same number of scan signals may be supplied to the visible display area VDA and the non-visible display area NVDA (e.g., two scan signals to each of the first and third-group scan lines S11 to S1k and S31 to S3j and one scan signal to each of the scan lines of the second-group scan lines S21 to S2n when n is equal to 2*(j+k)) during each horizontal period 1H. Accordingly, the driving load applied to the scan drivers 100, 200, or 300 may be continuously uniformly maintained during each frame period even without disposing a separate dummy element or dummy wiring for load matching. Therefore, according to the present embodiment, even when the peripheral area NA is not expanded, the display area 600 may exhibit a uniform luminance characteristic in at least the visible display area VDA irrespective of a region where the effective image is displayed and irrespective of the driving mode.

FIG. 12 illustrates a display device according to the present embodiment. In FIG. 12, the same or similar components as those of FIG. 3 are denoted by the same reference numerals, and a detailed description thereof will be omitted.

Referring to FIG. 12, in the display device according to the present embodiment, the scan drivers 100, 200, and 300 may be provided at opposite sides of the display area 600. For example, a display device according to the present embodiment may include two first scan drivers 100, two second scan drivers 200, and two third scan drivers 300. According to the present embodiment, one of the first scan drivers 100, one of the second scan drivers 200, and one of the third scan drivers 300 may be located at a first side of the display area 600, and the other of the first scan drivers 100, the other of the second scan drivers 200, and the other of the third scan drivers 300 may be located at a second side of the display area 600. According to the present embodiment, each of the scan lines S11 to S1k, S21 to S2n, and S31 to S3j may receive scan signals from the opposite sides thereof. Thus, even when the display area 600 may be expanded, it is possible to reduce signal delays occurring in the scan lines S11 to S1k, S21 to S2n, and S31 to S3j.

The display device according to the present embodiment may further include at least one driving circuit unit, such as a light emission control driver. For example, when the pixels PXL1, PXL2, and PXL3 further include light emission control transistors for controlling light emission periods, the display device may include at least one light emission control driver. The light emission control drivers may generate light emission control signals to overlap at least one scan signal supplied to a corresponding horizontal line in response to supply times of scan signals supplied to each horizontal line. The light emission control drivers may be implemented by various light emission control circuits known in the art, and thus a detailed description thereof will be omitted.

FIG. 13 schematically illustrates a display device according to the present embodiment. In FIG. 13, the same or similar components as those of FIG. 2 are denoted by the same reference numerals, and a repeated detailed description thereof will be omitted.

Referring to FIG. 13, the display device 10 according to the present embodiment may further include a dummy area DMA provided in a region of the peripheral area NA. According to the present embodiment, the dummy area DMA may be located on at least a side of the display area AA. For example, the dummy area DMA may be located adjacent to the third pixel area AA3 at a side of the third pixel area AA3. However, a position of the dummy area DMA may be located at various positions being limited thereto.

According to the present embodiment, at least one row of dummy pixels DPXL and at least one scan line connected thereto may be provided in the dummy area DMA. According to the present embodiment, the dummy pixels DPXL may have a same structure as the first, second, and/or third pixels PXL1, PXL2, and PXL3, but are not limited thereto. For example, in another embodiment, the dummy pixels DPXL may have a simpler structure than the first, second, and/or third pixels PXL1, PXL2, and PXL3.

The dummy area DMA may constitute a portion of a region invisible to the user (e.g., the non-visible display area NVDA covered by the frame 31 or the like). In the present embodiment, the dummy area DMA may be formed around the display area AA, and the display area 600 may be formed to exhibit a uniform luminance characteristic by using the dummy area DMA. A detailed description related to this will be given later.

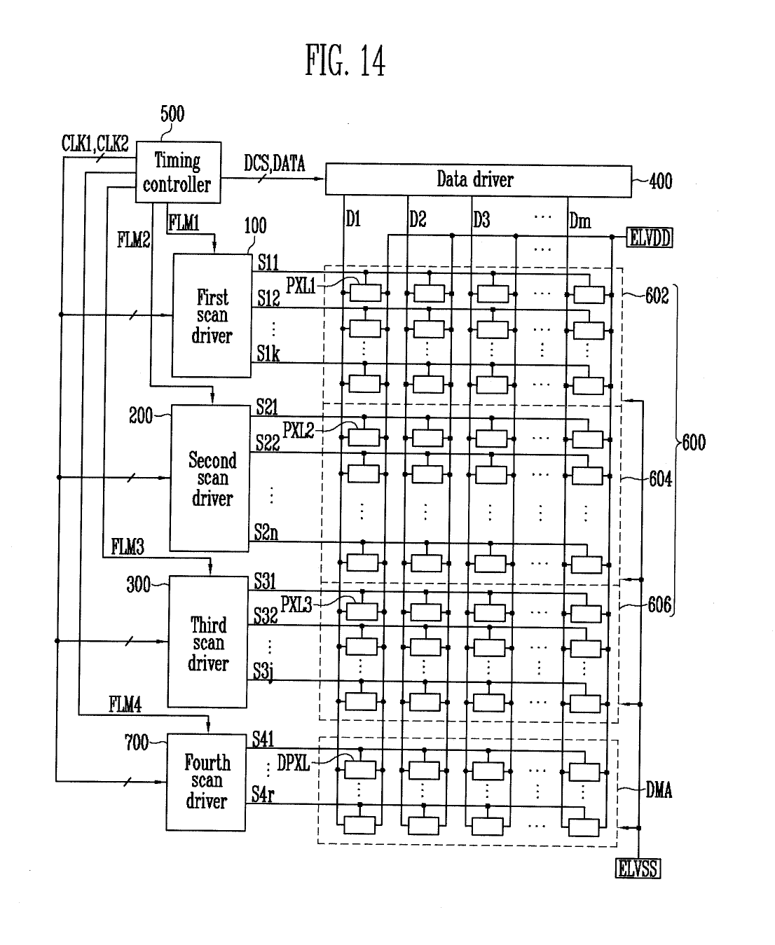

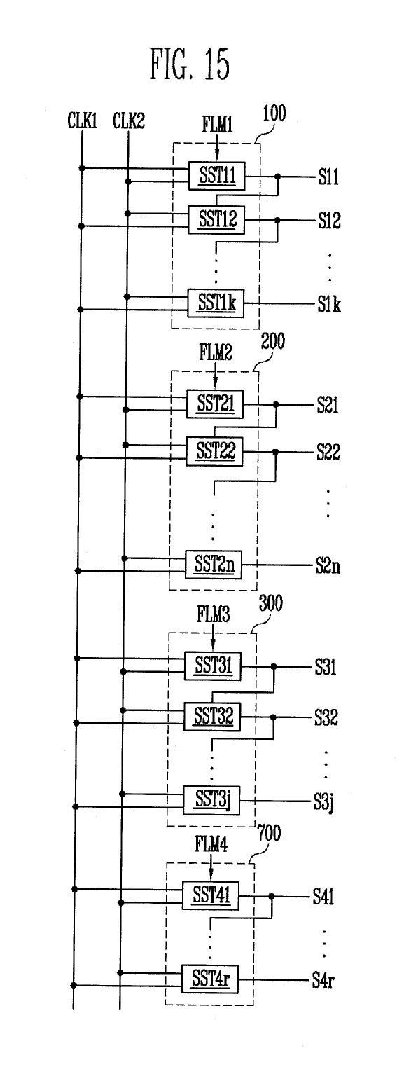

FIG. 14 illustrates a display device according to the present embodiment. FIG. 15 illustrates an example of scan drivers shown in FIG. 14. In FIG. 14 and FIG. 15, the same or similar components as those of FIG. 3 and FIG. 5 are denoted by the same reference numerals, and a repeated detailed description thereof will be omitted.

Referring to FIG. 14, the display device according to the present embodiment may further include a dummy area DMA provided around the display area 600, and a fourth scan driver 700 for driving the dummy area DMA. In addition, in the present embodiment, the timing controller 500 supplies, to the fourth scan driver 700, the clock signals CLK1 and CLK2 and a fourth start signal FLM4 for driving the fourth scan driver 700. For example, the timing controller 500 supplies the clock signals CLK1 and CLK2 and the fourth start signal FLM4 to the fourth scan driver 700 at least during a period in which the display device is driven in the second mode. The fourth start signal FLM4 controls supply times of the fourth scan signals, and the clock signals CLK1 and CLK2 supplied to the fourth scan driver 700 are used to shift the fourth start signal FLM4.

According to the present embodiment, a plurality of dummy pixels DPXL are provided in the dummy area DMA. For example, at least one row of dummy pixels DPXL may be provided in the dummy area DMA. In addition, one or more fourth-group scan lines S41 to S4r connected to each row of dummy pixels DPXL may be provided in the dummy area DMA. For example, when the dummy area DMA includes r horizontal lines (r being a natural number), r fourth-group scan lines S41 to S4r and r rows of dummy pixels DPXL connected thereto may be provided in the dummy area DMA. The dummy pixels PXL4 may receive fourth scan signals from the fourth scan driver 700 through the fourth-group scan lines S41 to S4r. For example, the dummy pixels PXL4 may receive the fourth scan signals from the fourth scan driver 700 during a period (e.g., a predetermined period) in which the display device is driven in the second mode.

For convenience, although an example in which the dummy pixels DPXL are connected with the data lines D1 to Dm is illustrated in FIG. 14, the present invention is not limited thereto. For example, in another embodiment, the dummy pixels DPXL may not disconnected from the data lines D1 to Dm. In addition, according to the present embodiment, light emission of the dummy pixels DPXL may be controlled by connecting the dummy pixels DPXL with light emission control lines. For example, a light emission control signal for maintaining a non-emission state of the dummy pixels DPXL may be supplied through the light emission control line.

Referring to FIG. 15, the fourth scan driver 700 includes fourth-group scan stages SST41 to SST4r connected to the fourth-group scan lines S41 to S4r. According to the present embodiment, a number of the fourth-group scan stages SST41 to SST4r may be variously changed depending on a number of horizontal lines provided in the dummy area DMA.

The fourth-group scan stages SST41 to SST4r receive the fourth start signal FLM4 and the clock signals CLK1 and CLK2 to sequentially supply a fourth scan signal to the fourth-group scan lines S41 to S4r in response to the fourth start signal FLM4. For example, the first fourth-group scan stage SST41 may supply the fourth scan signal to the first fourth-group scan line S41 in response to the fourth start signal FLM4. The other fourth-group scan stages SST42 to SST4r may respectively supply the fourth scan signal to a fourth-group scan line (any one of S42 to S4r) connected thereto in correspondence with an output signal of a respective previous single stage (e.g., a fourth scan signal of the previous single stage). Supply times of the fourth scan signals supplied to each of the fourth-group scan lines S41 to S4r may be determined to correspond to a supply time of the fourth start signal FLM4.

According to the present embodiment, when the display device is driven in the second mode, the fourth scan driver 700 may drive fourth-group scan lines S41 to S4r. In addition, when the display device is driven in the first mode, the fourth scan driver 700 may stop the driving, or may supply a bias voltage (e.g., a predetermined bias voltage) to the fourth-group scan lines S41 to S4r. For example, when the display device is driven in the first mode, the first to third pixel areas 602, 604, and 606 may be sequentially scanned, and the dummy area DMA might not be scanned as in the embodiment of FIG. 6 to FIG. 8.

When the display device is driven in the second mode, the dummy area DMA may be scanned with the horizontal lines of the second pixel area 604 during a period in which some horizontal lines of the second pixel area 604 are scanned. A detailed embodiment related to this will be described later.

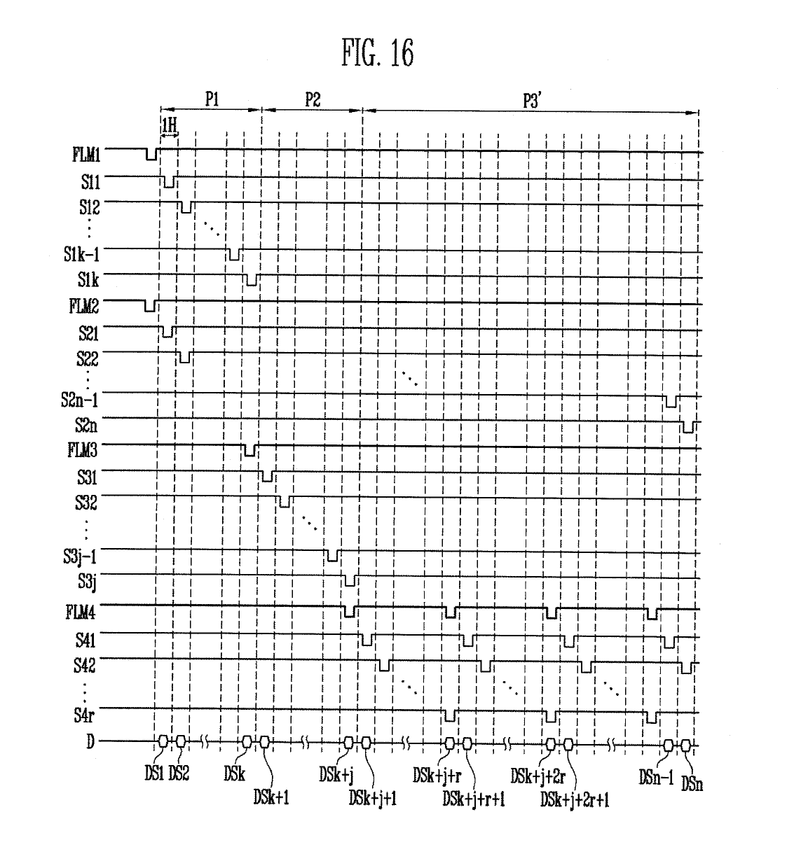

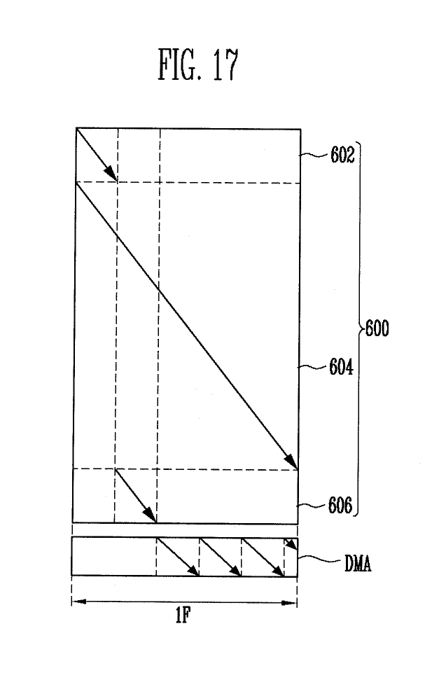

FIG. 16 illustrates an example of a driving timing of scan drivers when the display device shown in FIG. 14 is driven in the second mode. FIG. 17 schematically illustrates a supply order of scan signals supplied to a display area and a dummy area for each frame period when the display device shown in FIG. 14 is driven in the second mode. In FIG. 16 and FIG. 17, the same or similar components as those of FIG. 9 and FIG. 10 are denoted by the same reference numerals, and a repeated detailed description thereof will be omitted.

Referring to FIG. 16 and FIG. 17, when the display device is driven in the second mode, the timing controller 500 supplies the first start signal FLM1, the second start signal FLM2, the third start signal FLM3, and the fourth start signal FLM4 to the first scan driver 100, the second scan driver 200, the third scan driver 300, and the fourth scan driver 400, respectively (e.g., in a predetermined order). Herein, supply times of the first start signal FLM1, the second start signal FLM2, the third start signal FLM3, and the fourth start signal FLM4 are set such that the first-group scan lines S11 to S1k, the third-group scan lines S31 to S3j, and the fourth-group scan lines S41 to S4r are driven during different portions of a period in which the second-group scan lines S21 to S2n are sequentially driven. For example, in the present embodiment, when the display device is driven in the second mode, supply times of the first start signal FLM1, the second start signal FLM2, the third start signal FLM3, and the fourth start signal FLM4 may be set such that the second pixel area 604 is scanned during each frame period, and the first pixel area 602, the third pixel area 606, and the dummy area DMA are scanned during different periods. For example, when the display device is driven in the second mode, the first start signal FLM1, the second start signal FLM2, the third start signal FLM3, and the fourth start signal FLM4 may be set such that the first pixel area 602, the third pixel area 606, and the dummy area DMA are sequentially scanned during a period in which the second pixel area 604 is scanned, and, for example, may be set such that the dummy area DMA is repeatedly scanned until the scan of the second pixel area 604 is completed after each of the first pixel area 602 and the third pixel area 606 is scanned once.

To that end, the timing controller 500 may concurrently or simultaneously supply the first and second start signal FLM1 and FLM2 to the first and second scan drivers 100 and 200 in response to the second mode, and may supply the third start signal FLM3 to the third scan driver 300 in synchronization with the first scan signal when the first scan signal is supplied to the last first-group scan line S1k of the first-group scan lines S11 to S1k. In addition, in the case that sequential driving of the third-group scan lines S31 to S3j is completed while the second pixel area 604 is scanned, when the third scan signal is supplied to the last third-group scan line S3j, the timing controller 500 may supply the fourth start signal FLM4 to the fourth scan driver 400 in synchronization with the third scan signal supplied to the last third-group scan line S3j. Further, in the case that sequential driving of the fourth-group scan lines S41 to S4r is completed while the second pixel area 604 is scanned, when the fourth scan signal is supplied to the last fourth-group scan line S4r, the timing controller 500 may re-supply the fourth start signal FLM4 to the fourth scan driver 400 in synchronization with the fourth scan signal. Accordingly, the dummy area DMA may be repeatedly scanned until the scan of the second pixel area 604 is completed, and the scan of the dummy area DMA is completed when the scan of the second pixel area 604 is completed during each frame period.

For example, when the display device is driven in the second mode, one frame period may be set to include a plurality of horizontal periods corresponding to a number (e.g., n) of the second-group scan lines S21 to S2n. During each frame period, the second-group scan lines S21 to S2n may be sequentially driven once, and each of the first-group scan lines S11 to S1k and the third-group scan lines S31 to S3j may be sequentially driven until sequential driving of the second-group scan lines S21 to S2n is completed. The fourth-group scan lines S41 to S4r may be repeatedly sequentially driven from a time point when the first-group scan lines 811 to S1k and the third-group scan lines S31 to S3j are completed until sequential driving of the second-group scan lines S21 to S2n is completed.

In other words, in response to the second mode, the second scan driver 200 may supply the second scan signal to any one of the second-group scan lines S21 to S2n during each horizontal period 1H, and the first, third, and fourth scan driver 100, 300, and 700 may supply the first, third or fourth scan signal to one of the first-group scan lines 811 to S1k, one of the third-group scan lines S31 to S3j, or one of the fourth-group scan lines S41 to S4r during each of different ones of the horizontal periods. In this case, the first, third, or fourth scan signal may be supplied to overlap any one second scan signal during the corresponding horizontal period 1H.

For example, when one frame period includes first, second and third periods P1, P2 and P3′ that are sequentially connected, the first scan driver 100 may sequentially drive the first-group scan lines S11 to S1k during the first period P1 in which the second-group scan lines S21 to S2n are sequentially driven, and the third scan driver 300 may sequentially drive the third-group scan lines S31 to S3j during the second period P2 in which the second-group scan lines S21 to S2n are sequentially driven. The fourth scan driver 700 may repeatedly sequentially drive the fourth-group scan lines S41 to S4r during the third period P3′ in which the second-group scan lines S21 to S2n are sequentially driven.

In this case, during the first period P1, k first-group scan lines S11 to S1k may be sequentially driven, and k second-group scan lines (e.g., first to k^{th} second-group scan lines S21 to S2k) may be sequentially driven. For example, the first scan signal and the second scan signal may be respectively concurrently or simultaneously supplied to the first-group scan line S11 and the first second-group scan line S21, and the first scan signal and the second scan signal may be respectively concurrently or simultaneously supplied to the last k^{th} first-group scan line S1k and the k^{th} second scan line S2k.

Next, during the second period P2, j third-group scan lines S31 to S3j may be sequentially driven, and j second-group scan lines (e.g., (k+1)^{th} to (k+j)^{th} second-group scan lines S(2k+1) to S(2k+j)) may be sequentially driven. For example, the third scan signal and the second scan signal may be respectively concurrently or simultaneously supplied to the first third-group scan line S31 and the (k+1)^{th} second scan line S(2k+1), and the third scan signal and the second scan signal may be respectively concurrently or simultaneously supplied to the last/j^{th} third-group scan line S3j and the (k+j)^{th} second scan line S(2k+j).

Next, during the third period P3′, r fourth-group scan lines S41 to S4r may be sequentially driven, and r second-group scan lines (e.g., (k+j+1)^{th} to (k+j+r)^{th} second-group scan lines S(2k+j+1) to S(2k+j+r)) may be sequentially driven. In addition, during the third period P3′, the fourth-group scan lines S41 to S4r may be repeatedly sequentially driven.

When the second start signal FLM2 is supplied during each frame period of the period in which the second mode is executed, the second scan driver 200 sequentially supplies the second scan signal to the second-group scan lines S21 to S2n, and the data driver 400 outputs the data signals DS1 to DSn corresponding to effective images to be displayed in the second pixel area 604 in accordance with a driving time point of the second scan driver 200.

In other words, the data driver 400 sequentially supplies the data signals DS1 to DSn corresponding to the first horizontal line to the last horizontal line of the second pixel area 604 during each frame period in response to the second mode. The data signals DS1 to DSn are supplied to the second pixel area 604 to correspond to each second-group scan signal. Accordingly, effective images corresponding to the data signals DS1 to DSn are displayed in the second pixel area 604.

When the display device is driven in the second mode, the first to fourth scan drivers 100, 200, 300, and 700 respectively supply the scan signals to the first to fourth-group scan lines S11 to S1k, S21 to S2n, S31 to S3j, and S41 to S4r while repeating the aforementioned process.

According to the present embodiment, when the display device is driven in the second mode, effective images are displayed in some portions of the entire display area 600. For example, as shown in FIG. 11, the effective images may be displayed only in the second pixel area 604 in response to the second mode in the display area 600.

As described above, according to the present embodiment, even when the display device is driven in the second mode, a same number of scan signals may be supplied to the visible display area VDA and the non-visible display area NVDA (e.g., one scan signal to the first to third-group scan lines S11 to S1k, S21 to S2n, and S31 to S3j, and four scan signals to the fourth-group scan lines S41 to S4r when n is equal to k+j+4r) during each horizontal period 1H. Accordingly, the driving load applied to the scan drivers 100, 200, 300, and 700 may be continuously uniformly maintained during each frame period. Therefore, according to the present embodiment, the display area 600 may exhibit a uniform luminance characteristic in at least the visible display area VDA irrespective of a region where the effective image is displayed or the driving mode. Thus, it is possible to improve display quality of the display device.

While the technical spirits of embodiments of the present invention have been specifically described in accordance with the above-described embodiments, it should be noted that the above embodiments are for purposes of explanation only and not for the purpose of limitation. It will be understood by those skilled in the art that various changes in form and details may be made therein without departing from the scope of the present invention.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a display area comprising a first pixel area, a second pixel area, and a third pixel area, which are sequentially arranged, and configured to display an image at different areas depending on a first mode or a second mode;
first-group pixels and first-group scan lines in the first pixel area;
second-group pixels and second-group scan lines in the second pixel area;
third-group pixels and third-group scan lines in the third pixel area;
a first scan driver configured to drive the first-group scan lines;
a second scan driver configured to drive the second-group scan lines; and
a third scan driver configured to drive the third-group scan lines,
wherein, in the second mode, the second scan driver is configured to sequentially drive the second-group scan lines during one frame period, and the first and third scan drivers are configured to alternately drive the first-group scan lines and the third-group scan lines while the second-group scan lines are driven, and
wherein at least one of the first and third scan drivers repeatedly drives at least some of the first-group scan lines and the third-group scan lines two times or more during said one frame period in the second mode.

2. The display device of claim 1, wherein said one frame period comprises a plurality of horizontal periods, and
wherein the first scan driver, the second scan driver, and the third scan driver are configured to supply a same number of scan signals to corresponding scan lines of the first-group scan lines, the second-group scan lines, and the third-group scan lines during each of the horizontal periods in the second mode.

3. The display device of claim 1, wherein said one frame period comprises a plurality of horizontal periods,
the second scan driver is configured to supply a second scan signal to one of the second-group scan lines during each of the horizontal periods in response to the second mode, and
the first scan driver and the third scan driver are configured to alternately supply a first scan signal or a third scan signal to one of the first-group scan lines or one of the third-group scan lines during different ones of the horizontal periods.

4. The display device of claim 3, wherein the first scan signal or the third scan signal is supplied concurrently with the second scan signal.

5. The display device of claim 1, wherein said one frame period comprises sequential first, second, and third periods, and
wherein, in the second mode, the first scan driver is configured to sequentially drive the first-group scan lines during each of the first period and the third period, and the third scan driver is configured to sequentially drive the third-group scan lines during the second period.

6. The display device of claim 5, wherein said one frame period further comprises a fourth period following the third period, and
wherein the third scan driver sequentially drives the third-group scan lines during the fourth period in the second mode.

7. The display device of claim 5, wherein the second scan driver is configured to sequentially drive different ones of the second-group scan lines during each of the first period, the second period, and the third period.

8. The display device of claim 1, wherein the first scan driver, the second scan driver, and the third scan driver are configured to collectively sequentially drive the first-group scan lines, the second-group scan lines, and the third-group scan lines in the first mode.

9. The display device of claim 1, further comprising a timing controller configured to respectively supply a first start signal, a second start signal, and a third start signal to the first scan driver, the second scan driver, and the third scan driver.

10. The display device of claim 9, wherein the timing controller is configured to sequentially supply the first start signal, the second start signal, and the third start signal in the first mode.

11. The display device of claim 9, wherein the timing controller is configured to concurrently supply the first start signal and the second start signal in the second mode.

12. The display device of claim 11, wherein the timing controller is configured to supply the third start signal in synchronization with a first scan signal supplied to a last first-group scan line of the first-group scan lines.

13. The display device of claim 1, further comprising:
data lines in the display area crossing the first-group scan lines, the second-group scan lines, and the third-group scan lines; and
a data driver configured to supply a data signal to the data lines.

14. The display device of claim 13, wherein the data driver is configured to sequentially supply a data signal corresponding to a first horizontal line to a last horizontal line of the second pixel area during said one frame period in the second mode.

15. The display device of claim 1, wherein the display area is configured to displays the image in the first pixel area, the second pixel area, and the third pixel area in response to the first mode, and is configured to display the image only in the second pixel area in the second mode.

16. The display device of claim 1, wherein the display device is configured to be driven in the second mode when mounted to a wearable device covering the first pixel area and the third pixel area, and is configured to be driven in the first mode otherwise.

17. A driving method of a display device comprising a first pixel area, a second pixel area, and a third pixel area, which are sequentially arranged, the method comprising:
supplying a data signal to the first pixel area, the second pixel area, and the third pixel area while sequentially scanning the first pixel area, the second pixel area, and the third pixel area when the display device is driven in a first mode; and
supplying a data signal to the second pixel area while scanning the second pixel area, and alternately scanning the first pixel area and the third pixel area while the second pixel area is scanned, when the display device is driven in a second mode,
wherein the first pixel area and the third pixel area are repeatedly scanned until the scan of the second pixel area is completed when the display device is driven in the second mode.

18. The driving method of claim 17, further comprising concurrently supplying a scan signal to a first first-group scan line of the first pixel area and to a first second-group scan line of the second pixel area when the display device is driven in the second mode.

19. The driving method of claim 18, further comprising, when the display device is driven in the second mode:
concurrently supplying the scan signal to a last first-group scan line of the first pixel area and to a k^{th} (k is a natural number that is greater than 2) second-group scan line of the second pixel area during a k^{th} horizontal period in each frame period; and
concurrently supplying the scan signal to a (k+1)^{th} second-group scan line of the second pixel area and to a first third-group scan line of the third pixel area during a (k+1)^{th} horizontal period that is subsequent to the k^{th} horizontal period.

20. The driving method of claim 17, further comprising displaying an image in the first pixel area, the second pixel area, and the third pixel area when the display device is driven in the first mode; and
displaying the image only in the second pixel area when the display device is driven in the second mode.
